(19) United States
(12) Patent Application Publication
(10) Pub. No.: US 2020/0104953 A1
(43) Pub. Date: Apr. 2, 2020

(54) System and Method for Generating Forensic Documents Using a Feedback Loop System with Field Data

(71) Applicant: Jarrod C. Burns, Rosenberg, TX (US)

(72) Inventor: Jarrod C. Burns, Rosenberg, TX (US)

(73) Assignee: BSC Forensics, LLC, Rosenberg, TX (US)

(21) Appl. No.: 16/703,758

(22) Filed: Dec. 4, 2019

Related U.S. Application Data
(63) Continuation-in-part of application No. 15/849,476, filed on Dec. 20, 2017.

(51) Int. Cl. G06Q 50/18; G06Q 10/06; G06F 16/23; G06F 16/683; G06F 16/48; G10L 15/26

(52) U.S. Cl. CPC G06Q 50/18; G06Q 10/06316; G10L 15/265; G06F 16/685; G06F 16/48; G06F 16/2365

(57) ABSTRACT

In an illustrative embodiment, the method and system creates forensic engineering reports for use in legal proceedings with minimal errors from field evidence. The method and system may be a workflow implemented using program instructions hosted on a cloud, where the program instructions may be executed on-demand from multiple locations. Evidence is uploaded to the workflow and input into template reports and documents with feedback loops for error minimization.

### BACKGROUND

Structures may fail for a variety of reasons. The failure could be the result of a natural disaster, years of deterioration and poor maintenance, or due to some sort of human intervention. Additionally, although the ultimate failure may be discovered or occur as a result of a natural disaster, the ultimate cause of the failure may be due to years of deterioration, whether that deterioration is perfectly normal or whether it is due to a lack of maintenance. In these cases, and particularly in the wake of some sort of natural disaster or failure, it may be difficult to discern what the causes of the structural failure were. It becomes important to find the causes of structural failure to also determine who should ultimately bear the cost of repair. In these cases, forensic engineers with expertise in structural engineering are called to provide expert analyses to help in the determination.

The analyses are typically supported by observations, photos, audio, and/or videos—evidence—from the site of the structural failure. The forensic engineers or the forensic engineering companies take this evidence and incorporate them into documents or reports to be used by the attorneys, companies, and people involved with the structure in question. Since several occurrences or factors can contribute, these reports and documents need to include detailed analyses of the possibilities and of the facts found on site. Therefore, the more accurate and detailed the reports are, the better and easier it is for those involved to make decisions and discern the causes of the structural failure.

Automated systems and detailed processes minimize error and increase the inclusion of relevant details such as supporting evidence in the final reports and documents. The method and system disclosed provides a process for taking field-gathered evidence and producing an accurate report ready to be used in a legal proceeding.

### SUMMARY OF ILLUSTRATIVE EMBODIMENTS

The present invention is directed at a method and system for creating forensic engineering reports for use in legal proceedings with minimal errors from field evidence. Within this document and the associated claims, these forensic engineering reports for use in legal proceedings may be referred to as “forensic documents.” An example of these types of forensic documents may include reports on structural failures, or may include damage to property. In one, illustrative embodiment, the method and system consists of a workflow that may be implemented using a processor and a memory operably coupled to the processor and having program instructions stored therein, where the processor is operable to execute the program instructions. In another illustrative embodiment, the method and system consists of a workflow that may be implemented using program instructions hosted on a cloud, the program instructions may be executed on-demand from multiple locations.

The workflow initiates with the creation of a project. Then, from a remote site location, evidence pieces are added to the project, where at least one has an audio component and at least one has a visual component. Then, either a person or a program instruction triggers a transcription of the audio component and pairs and tags the visual component to match up with the transcribed audio. The transcribed audio with visual evidence are the main components of a final report or set of documents to be used in legal proceedings.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 Flow chart depicting a process and system for receiving field photographs and data and integrating into an automatically updated document

FIG. 2. A flowchart depicting a template document with linked fields and a feedback loop for automated updates.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values there between.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

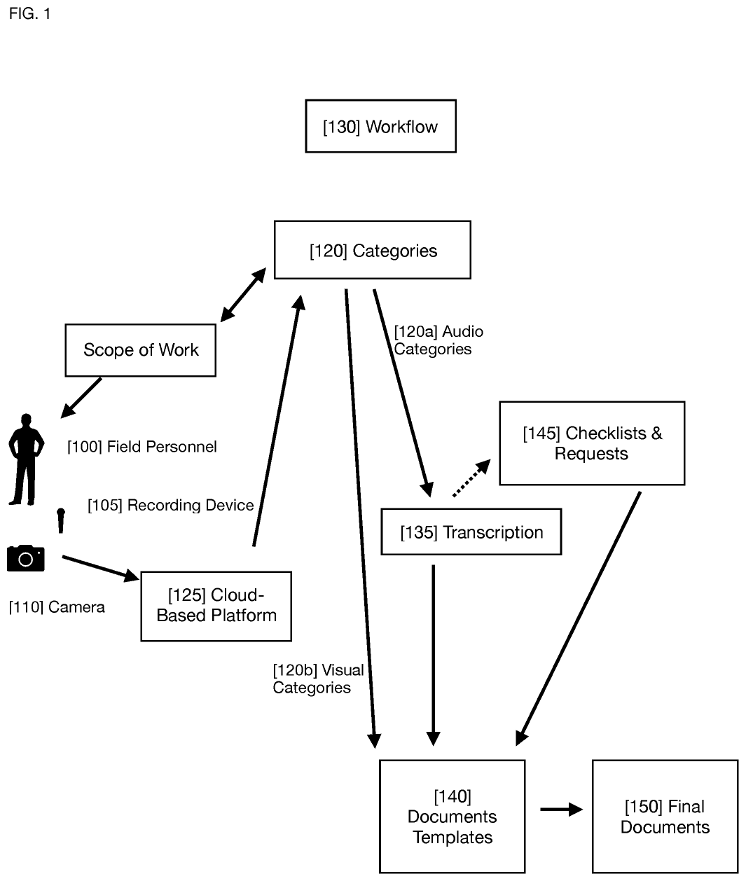

FIG. 1 depicts a flow chart representing field personnel using a system and method to create a detailed, customer-facing document. In the depicted figure, a field personnel [100] receives a scope of work to assess what inputs are needed, and then field data is collected in a digital format, using a recording device [105] and a camera [110], producing digital audio inputs and digital visual inputs, which could be digital photographs or digital video. The recording device contains a real-time recording of the necessary inputs from the field location. The camera [110] may record digital photographs, digital videos, or both. In this application, “photographs,” “video,” “visual inputs,” and “visual” are used interchangeably and are always digital in nature. Typically, the photographs and video may be of physical structures, buildings, or other inanimate objects that have been damaged or otherwise struck by another object. The field personnel [100] has instructions from a scope of work [115] with communicated or standard specific categories [120] of items to record or document on, where the categories have meaning or relevance to collect “evidence” or are evidentiary in nature. After completion, the recording and the photographs or video are uploaded to a cloud-based platform [125] under the specific categories [120], such as audio categories [120a] or visual categories [120b], where an example of the cloud-based platform is a project management platform or a cloud-based file storage. Furthermore, this cloud-based platform hosts processing capabilities and is further programmable with logic. Uploading the data into a project folder, and/or changing the system status, triggers the remaining steps in the workflow [130]. The recording then enters an automatic transcription workflow [135], where the audio recording is converted to the written word. The visual categories [120b] and the transcription created from the automatic transcription workflow [135] populates template documents [140], where the transcription creates informational inputs as opposed to visual inputs from the visual categories. Simultaneously, checklists and requests to other personnel [145] are created to continue the document generation process, where additional informational inputs may be requested from the field personnel. Finally, a final document or set of documents [150] are created that is error-reduced. This process ensures an error-reduced document is created with minimal input from personnel, advantageously saving time and labor while increasing document quality and minimizing error.

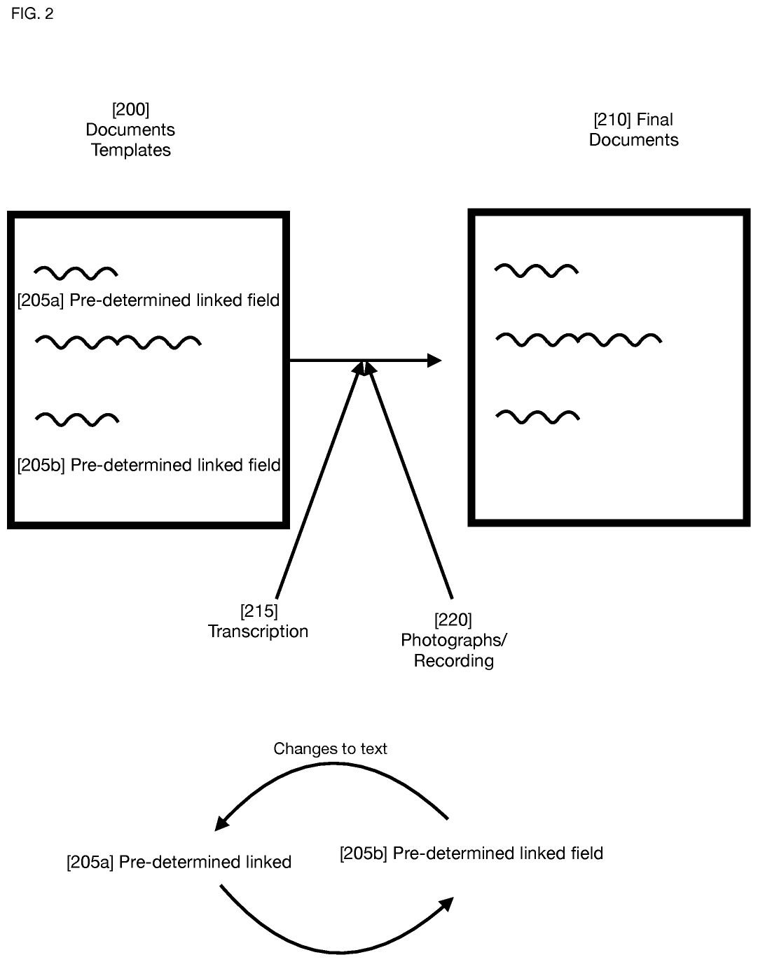

FIG. 2 depicts an exemplary document with linked fields. Embedded in the document creation system overview depicted in FIG. 1, the document templates [200] have pre-determined linked fields [205a] and [205b]. When the final documents [210] are populated from the transcription [215] and the photographs or recordings [220], any changes to linked field [205a] would automatically change field [205b], and vice versa. The creation of an automatically updating feedback loop system for the document creation advantageously increases consistency and operational efficiency in the forensic document creation process.

In some embodiments, the document creation system may contain video or photographs or a combination of both. The video may not be embedded in the document directly but may be incorporated into the documents by other means, such as still images. This may require additional checklists or workflows to be created.

In some embodiments, the field personnel may be assisted by an automated flying photograph or video capture device, commonly known as a drone. The field personnel may simply be dictating into the recording device while watching the drone footage and may not be in the field.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A system for generating forensic engineering documents using automated feedback loops, the system executable by a processor containing logic or a series of instructions that, when executed by the processor, with the proper inputs, cause the processor to perform the automated feedback loops, the system comprising:
at least one form scope of work with evidentiary categories to be automatedly populated with digital audio and photographic visual data from a said field study hosted on a cloud-based project management tool platform, which hosts the processor;
a collection of data from a field study, where collected data includes digital audio on a field recording device and visual data on a photo or video capture device;
an initial digital audio input into from a field recording device and an initial digital pictorial visual input from a photo or video capture device uploaded to a cloud-based file storage used in direct conjunction with the said cloud-based project management tool platform and assigned to the said evidentiary categories;
where uploading said initial digital audio input to said cloud-based project management tool platform prompts a transcription program to convert said initial digital audio input into a written transcription;
where converting said digital audio input into a transcription triggers automatedly placing the said digital visual input at tagged points in the transcription;
where converting said digital initial audio input into a written transcription triggers sending of form checklists and task lists for additional informational inputs and verification;
the said written transcription, the said initial digital pictorial visual input, and the said additional informational inputs, populate a designated field in a document template to generate at least one final forensic engineering document ready for use in a legal proceeding; and
where the said final forensic engineering document contains fields linking to all similar values within the said final forensic engineering document so that any changes made to one field in the said final forensic engineering document automatically updates all other linked fields within the said final forensic engineering document; and
the system producing an error-reduced final forensic engineering document with said visual data and said transcription ready for use in legal proceedings.

2. A method for generating forensic engineering documents using automated feedback loops, the method executable by a processor containing logic or a series of instructions that, when executed by the processor, with the proper inputs, cause the processor to perform the automated feedback loops, the method comprising:
populating at least one form with evidentiary categories to be populated with audio and photographic data from a field study hosted on a cloud-based project management tool platform;
a collection of data from a field study, where collected data includes digital audio on a field recording device and visual data on a photo or video capture device;
uploading an initial digital audio input into a field recording device and an initial digital pictorial visual input from a photo or video capture device uploaded to a cloud-based file storage used in direct conjunction with the said cloud-based project management tool platform and assigned to the said evidentiary categories;
where uploading said initial digital audio input to said cloud-based project management tool platform prompts a transcription program to convert said initial digital audio input into a written transcription;
where converting said digital audio input into a transcription triggers automatedly placing the said digital visual input at tagged points in the transcription;
where converting said initial audio input into a written transcription triggers sending of a form checklists and a task lists for additional informational inputs and verification;
the said written transcription, the said initial digital pictorial visual input, and the said additional informational inputs, populate a designated field in a document template to generate at least one final forensic engineering document;
where the said final forensic engineering document contains fields linking to all similar values within the said final forensic engineering document so that any changes made to one field in the said final forensic engineering document automatically updates all other linked fields within the said final forensic engineering document; and
the system producing an error-reduced final forensic engineering document with said visual data and said transcription ready for use in legal proceedings.

3. A computerized method for generating a forensic document for use in legal proceeding using automated feedback loops comprising:
creating, by a processor, a work project on a local server or a remote server;
receiving, by a processor, a plurality of user uploaded evidence pieces comprising at least one digital audio component and at least one digital visual component, wherein the evidence pieces are assigned to evidentiary categories; and
populating, by a processor, at least one form with the evidentiary categories and storing on a cloud-based project management platform.

4. The computerized method of claim 3, wherein uploading evidentiary pieces further comprises, converting automatedly, by a processor using a transcription program installed thereon, the digital audio components into a digital transcription, and the digital visual components into a plurality of informational inputs.

5. The computerized method of claim 4, further comprising, transmitting automatedly, by the processor, a form checklist and a task list for additional user informational inputs and verification.

6. The computerized method of claim 5, further comprising, populating, by a processor, a designated field in a document template to generate at least one final forensic document ready for use in a legal proceeding, by using said transcription, the digital visual input and the additional informational inputs.

7. The computerized method of claim 6, wherein said final forensic document contains fields linking to all similar values within said final document so that any changes made to one field automatically updates all other linked fields.
